(19) United States
(12) Patent Application Publication
(10) Pub. No.: US 2024/0347866 A1
(43) Pub. Date: Oct. 17, 2024

(54) INSULATION SPACER, BATTERY CELL, BATTERY, AND ELECTRICAL DEVICE

(71) Applicant: Ningde Amperex Technology Limited, Ningde (CN)

(72) Inventors: Jing YU, Ningde (CN); Xinlei WANG, Ningde (CN)

(73) Assignee: Ningde Amperex Technology Limited, Ningde (CN)

(21) Appl. No.: 18/751,792

(22) Filed: Jun. 24, 2024

Related U.S. Application Data
(63) Continuation of application No. PCT/CN2021/141229, filed on Dec. 24, 2021.

(51) Int. Cl. H01M 50/48; H01M 50/474; H01M 50/477; H01M 50/533; H01M 50/536

(52) U.S. Cl. CPC H01M 50/48; H01M 50/474; H01M 50/477; H01M 50/533; H01M 50/536

(57) ABSTRACT

An insulation spacer applicable to a battery cell. The battery cell further includes a shell, a first tab, and a second tab of an opposite polarity to the first tab. The first tab is insulated from the shell. The insulation spacer includes a first wall face and a second wall face opposite to each other along a thickness direction of the insulation spacer. A first hole that penetrates the first wall face and the second wall face is created on the insulation spacer. A direction from the first wall face to the second wall face is a first direction. The first hole is configured to be passed through by the first tab along the first direction and enable the first tab to bend to closely fit the second wall face.

### CROSS-REFERENCE TO RELATED APPLICATION

This application is a continuation of International Patent Application No. PCT/CN2021/141229, filed on Dec. 24, 2021, the disclosure of which is hereby incorporated by reference in its entirety.

### TECHNICAL FIELD

This application relates to the technical field of batteries, and in particular, to an insulation spacer, a battery cell, a battery, and an electrical device.

### BACKGROUND

An electrode assembly is disposed in a housing of a battery cell. The electrode assembly includes two tabs of opposite polarities. The two tabs are connected to electrode posts of the housing of the battery cell so that an electrical current can be conducted out of the battery cell. To make the tabs closely fit the electrode posts, an insulation spacer is disposed between the electrode assembly and the electrode posts. The tabs closely fit onto the insulation spacer. The insulation spacer and the electrode posts jointly squeeze the tabs so that the tabs are stably connected to the electrode posts.

In the related art, both tabs are bent around a lateral edge of the insulation spacer from a wall face, oriented away from the electrode posts, of the insulation spacer until the tabs closely fit a wall face, oriented toward the electrode posts, of the insulation spacer. A part, located on the lateral edge of the tabs, of the insulation spacer is prone to contact the housing of the battery cell, thereby resulting in a short circuit and inferior safety performance.

### SUMMARY

An objective of some embodiments of this application is to provide an insulation spacer, a battery cell, a battery, and an electrical device to improve safety of the battery cell.

To achieve the above objective, a technical solution of this application is to provide an insulation spacer applicable to a battery cell. The battery cell further includes a shell, a first tab, and a second tab of an opposite polarity to the first tab. The first tab is insulated from the shell. The insulation spacer includes a first wall face and a second wall face opposite to each other along a thickness direction of the insulation spacer. A first hole that penetrates the first wall face and the second wall face is created on the insulation spacer. A direction from the first wall face to the second wall face is a first direction. The first hole is configured to be passed through by the first tab along the first direction and enable the first tab to bend to closely fit the second wall face. In this technical solution, a first hole is created on the insulation spacer. The tab that needs to be insulated from the housing of the battery cell can pass through the first hole. In this way, the bent part of the tab at the thickness position of the insulation spacer is prevented from contacting the housing of the battery cell, and a short circuit caused by the contact is avoided, thereby improving safety performance of the battery cell.

Further, in an embodiment, the first tab includes an intermediate portion located in the first hole. The intermediate portion is wrapped with a tab adhesive. A thickness direction of the intermediate portion is a second direction. Along the second direction, a dimension L1 of the first hole, a thickness L2 of the first tab, and a thickness L3 of the tab adhesive satisfy: 3≤L1/(L2+L3)≤5. In this technical solution, when L1/(L2+L3) is overly small, the process of the tab passing through the first hole is troublesome. When L1/(L2+L3) is overly large, the first hole is unable to constrain the tab, thereby causing the tab to wobble in the first hole along the second direction Y. Therefore, the applicant hereof has demonstrated through experiments that, when the value of L1/(L2+L3) falls between three and five, not only the first tab can pass through the first hole conveniently, but also the first hole can well constrain the intermediate portion of the first tab.

Further, in an embodiment, the first tab includes an intermediate portion located in the first hole. The intermediate portion is wrapped with a tab adhesive. A thickness direction of the intermediate portion is a second direction. A direction perpendicular to the first direction and perpendicular to the second direction is a third direction. Along the third direction, a dimension L4 of the first hole and a width L5 of the tab adhesive satisfy: 1.2≤L4/L5≤1.5. In this technical solution, the applicant hereof has demonstrated that, when 1.2≤L4/L5≤1.5, the first hole not only facilitates passage of the first tab, but also well constrains the first tab.

Further, in an embodiment, the first tab includes an intermediate portion located in the first hole. The intermediate portion is wrapped with a tab adhesive. A thickness direction of the intermediate portion is a second direction. Along the second direction, the insulation spacer includes a first lateral edge and a second lateral edge arranged opposite to each other. A shortest distance H1 from the first hole to the first lateral edge and a distance H2 from the first lateral edge to the second lateral edge satisfy: 0.25≤H1/H2≤0.5. In this technical solution, the applicant hereof demonstrates that, when 0.25≤H1/H2≤0.5, the arrangement space can meet requirements after the first tab passes through the insulation spacer. At the same time, the distance between the first tab and the lateral edge of the insulation spacer meets the requirements. The risk of contact between the first tab and the shell is low.

Further, in an embodiment, the first wall face and/or the second wall face is connected to a supporting portion. The supporting portion is disposed between the first hole and the first lateral edge. The supporting portion includes a third wall face oriented away from the first lateral edge. The first hole includes a first hole wall close to the first lateral edge. The first hole wall and the third wall face are consecutive and combine to form a continuous wall face. In this technical solution, the supporting portion enables the first hole wall of the first hole to flare out along the first direction X (the flared wall face is called a continuous wall face), where the first hole wall is close to the first lateral edge of the insulation spacer. In this way, the continuous wall face more effectively supports the intermediate portion of the first tab, thereby effectively avoiding the risk that the intermediate portion detaches from the first hole wall, moves toward the first lateral edge of the insulation spacer, and comes into contact with the shell of the battery cell.

Further, in an embodiment, the continuous wall face is a flat face. Alternatively, the continuous wall face is an arc face. The continuous wall face is recessed toward the first lateral edge from an interior of the insulation spacer along a thickness direction of the insulation spacer. In this technical solution, the continuous wall face more effectively supports the intermediate portion of the first tab, and can more effectively prevent the intermediate portion from detaching from the continuous wall face.

Further, in an embodiment, along the first direction, a width M1 of the continuous wall face and a width M2 of the first hole wall satisfy: 1.5≤M1/M2≤2. In this technical solution, the applicant hereof finds that, when 1.5≤M1/M2≤2, the overall thickness of the insulation spacer is not overly large, thereby preventing the insulation spacer from occupying too much space in the battery cell. In addition, the dimension of the continuous wall face along the first direction X is not overly small, thereby ensuring that the continuous wall face can effectively support the intermediate portion of the first tab.

Further, in an embodiment, a direction perpendicular to the first direction and perpendicular to the second direction is a third direction. Along the third direction, a length of the third wall face is identical to a length of the first hole wall. In this technical solution, the effect of supporting the intermediate portion of the first tab is improved.

Further, in an embodiment, the first hole further includes a second hole wall close to the second lateral edge. A first groove is created at a part of the second wall face, and the part is located between the first hole and the second lateral edge. The first groove extends to the second lateral edge and the second hole wall separately. The first groove is configured to accommodate at least a part of the first tab along the first direction. In this technical solution, the part, passing through the first hole, of the first tab can be accommodated in the first groove and constrained by the first groove, thereby preventing the part, passing through the first hole, of the first tab from moving along the second direction Y. In addition, in an embodiment, the first groove can also reduce the thickness of the insulation spacer, thereby reducing the space occupied by the insulation spacer in the battery cell and increasing the energy density of the battery cell.

Further, in an embodiment, a direction perpendicular to the first direction and perpendicular to the second direction is a third direction. Along the third direction, a dimension of the first groove is equal to a dimension of the first hole. In this technical solution, the first groove is more easily processable, and can match the dimension of the first tab along the second direction Y. In this way, on the one hand, the first tab is prevented from being stuck by the overly small dimension of the first groove along the second direction Y. On the other hand, the effect of the first groove in constraining the first tab is prevented from being weakened by the overly large dimension of the first groove along the second direction Y.

Further, in an embodiment, along the first direction, a depth L6 of the first groove and a thickness L2 of the first tab satisfy: 0.8≤L6/L2≤1. In this technical solution, when 0.8≤L6/L2≤1, the first groove is prevented from being overly deep and in turn resulting in an excessive thickness of the insulation spacer, and the first groove is also prevented from being overly shallow and in turn ineffective in constraining the first tab.

Further, in an embodiment, the first hole further includes a second hole wall close to the second lateral edge. A second groove is created at a part of the first wall face, and the part is located between the first hole and the second lateral edge. The second groove extends to the second lateral edge and the second hole wall separately. The second groove is configured to accommodate at least a part of the first tab along the first direction. In this solution, the second groove is configured to constrain the first tab located on one side of the first wall face of the insulation spacer, so that the first tab is positioned more properly.

Further, in an embodiment, a direction perpendicular to the first direction and perpendicular to the second direction is a third direction. Along the third direction, a dimension of the second groove is equal to a dimension of the first hole. In this technical solution, the second groove is more easily processable, and the second groove can match the dimension of the first tab along the second direction Y.

Further, in an embodiment, a tab adhesive is disposed at a part of the first tab, and the part is located in the second groove. Along the first direction, a depth L7 of the second groove, a thickness L2 of the first tab, and a thickness L3 of the tab adhesive satisfy: 0.8≤L7/(L2+L3)≤1. In this technical solution, the second groove is prevented from being overly deep and in turn resulting in an excessive thickness of the insulation spacer, and the second groove is also prevented from being overly shallow and in turn ineffective in constraining the first tab.

Further, in an embodiment, a second hole penetrating the first wall face and the second wall face is further created on the insulation spacer. The second hole is configured to be passed through by the second tab along the first direction and enable the second tab to bend to closely fit the second wall face. In this technical solution, the second tab is prevented from contacting the shell, thereby reducing safety hazards.

Further, in an embodiment, a notch is created at the first lateral edge. The notch is configured to accommodate the second tab. The notch includes a fourth wall face away from the first lateral edge. The first hole includes a second hole wall away from the first lateral edge. The fourth wall face is parallel to or coplanar with the second hole wall. In this technical solution, the assembling of the second tab is facilitated.

A second aspect of this application further provides a battery cell. The battery cell includes the insulation spacer disclosed in any one of the above embodiments.

A third aspect of this application further provides a battery. The battery includes one or more battery cells disclosed above.

A fourth aspect of this application further provides an electrical device. The electrical device includes the battery disclosed above.

On the insulation spacer provided in this application, a first hole is created, and the tab that needs to be insulated from the housing of the battery cell can pass through the first hole. In this way, the bent part of the tab at the thickness position of the insulation spacer is prevented from contacting the housing (such as an upper housing or a lower housing) of the battery cell, and a short circuit caused by the contact is avoided, thereby improving safety performance of the battery cell.

### BRIEF DESCRIPTION OF DRAWINGS

To describe the technical solutions of some embodiments of this application more clearly, the following outlines the drawings used in the embodiments of this application. Evidently, the drawings outlined below are merely a part of embodiments of this application. A person of ordinary skill in the art may derive other drawings from the outlined drawings without making any creative efforts.

FIG. 1 is a three-dimensional schematic diagram of an insulation spacer according to a first embodiment of this application;

FIG. 2 is a schematic front view of an insulation spacer according to a first embodiment of this application;

FIG. 3 is a schematic front view of an insulation spacer according to a first embodiment of this application, in which dimensions H1 and H2 are shown;

FIG. 4 is a three-dimensional schematic diagram of an insulation spacer according to a second embodiment of this application;

FIG. 5 is a close-up view of a part A shown in FIG. 4;

FIG. 6 is a schematic front view of an insulation spacer according to a second embodiment of this application;

FIG. 7 is a schematic cross-sectional view of sectioning along a D-D direction shown in FIG. 6;

FIG. 8 is a schematic cross-sectional view of sectioning along a D-D direction shown in FIG. 6, in which dimensions M1 and M2 are shown;

FIG. 9 is a three-dimensional schematic diagram of an insulation spacer according to a third embodiment of this application;

FIG. 10 is a three-dimensional schematic diagram of an insulation spacer assembled with a first tab and a second tab according to a third embodiment of this application;

FIG. 11 is a schematic front view of an insulation spacer assembled with a first tab and a second tab according to a third embodiment of this application;

FIG. 12 is a schematic cross-sectional view of an insulation spacer assembled with a first tab and a second tab according to a fourth embodiment of this application;

FIG. 13 is a schematic cross-sectional view of an insulation spacer assembled with a first tab and a second tab according to a fourth embodiment of this application, in which dimensions L1, L2, L2+L3, and L6 are shown;

FIG. 14 is a schematic cross-sectional view of an insulation spacer assembled with a first tab and a second tab according to a fourth embodiment of this application, in which dimensions L1, L2, L2+L3, L6, and L7 are shown and the first tab is sectioned;

FIG. 15 is a schematic front view of an insulation spacer assembled with a first tab and a second tab according to a fourth embodiment of this application;

FIG. 16 is a three-dimensional schematic diagram of an insulation spacer according to a fifth embodiment of this application;

FIG. 17 is a schematic front view of an insulation spacer according to a fifth embodiment of this application; and

FIG. 18 is a schematic cross-sectional view of a battery cell according to a first embodiment of this application.

### DETAILED DESCRIPTION

For ease of understanding this application, the following describes this application in more detail with reference to drawings and specific embodiments. It is hereby noted that an element referred to herein as being “fixed to” another element may be directly disposed on the other element, or may be fixed to the other element with one or more elements in between. An element referred to herein as “connected to” another element may be connected to the other element directly or with one or more elements in between. The terms “vertical”, “horizontal”, “left”, “right”, and other similar expressions used herein are merely for ease of description.

Unless otherwise defined, all technical and scientific terms used herein bear the same meanings as what is normally understood by a person skilled in the technical field of this application. The terms used in the specification of this application are merely intended to describe specific embodiments but not to limit this application. The term “and/or” used herein is intended to include any and all combinations of one or more relevant items recited.

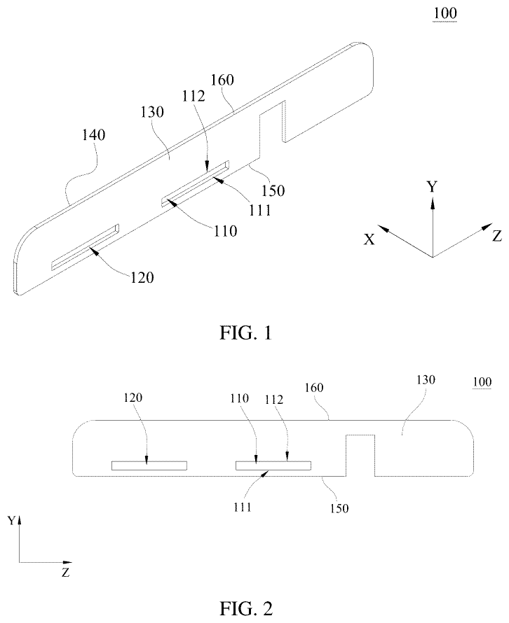

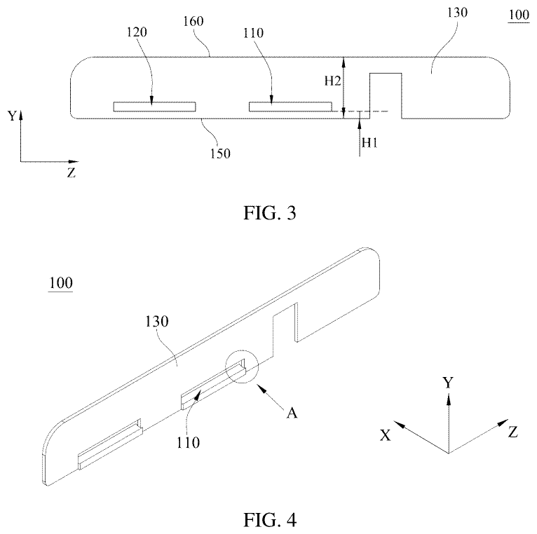

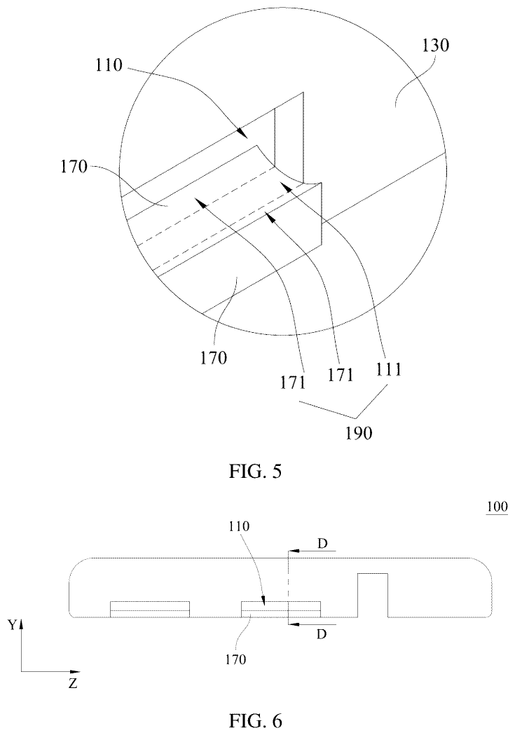

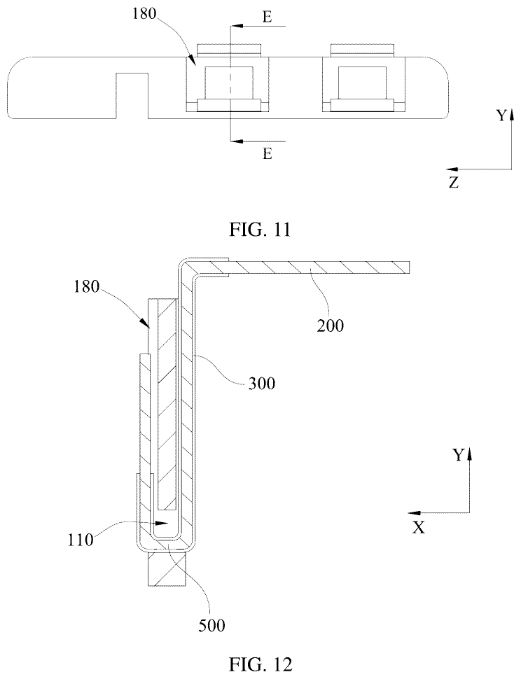

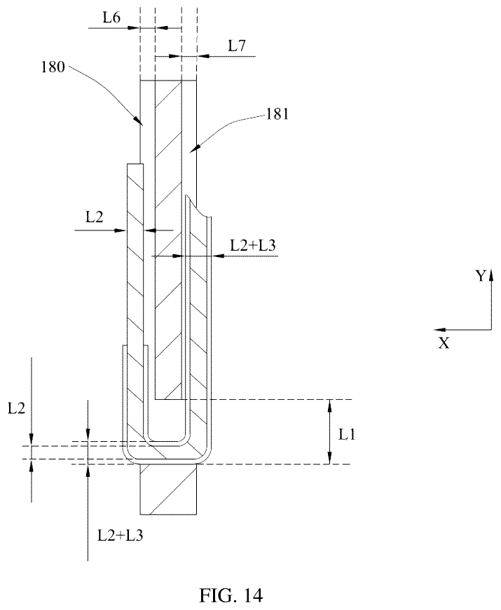

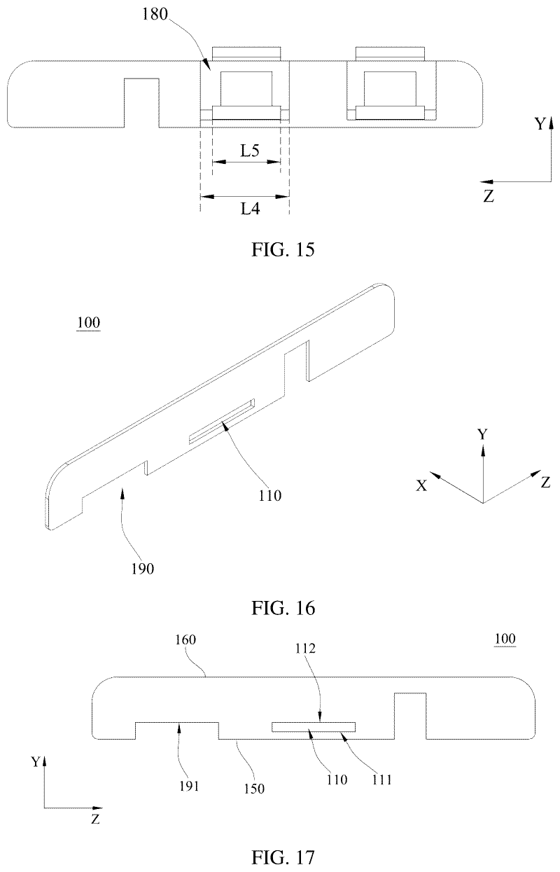

Referring to FIG. 1 to FIG. 18, this application provides an insulation spacer 100. The insulation spacer 100 can improve the safety performance of the battery cell 10. Specifically, the insulation spacer 100 is applicable to the battery cell 10. The battery cell 10 further includes a shell 12, an electrode assembly 13, an electrode post 11, and an insulation spacer 100. The electrode assembly 13 includes a first tab 200 and a second tab 400 of an opposite polarity to the first tab 200. The first tab 200 is insulated from the shell 12.

It is hereby noted that, among different types of battery cells 10, the shell 12 of some battery cells 10 includes two tabs inside, and the shell 12 of some other battery cells 10 includes more tabs inside. In the shell 12 of some battery cells 10, a tab of one polarity is electrically connected to the shell 12 of the battery cell 10, and the tab of the other polarity is insulated from the shell 12 (when insulated from the shell 12, the tab may be electrically connected to the electrode post 11 disposed on the shell 12). In some battery cells 10, no tab is electrically connected to the shell 12 of the battery cell 10 (for example, the tabs may be electrically connected to different electrode posts 11 disposed on the shell 12, respectively). Regardless of the type of the battery cell, once a tab designed to be insulated from the shell 12 is electrically connected to the shell 12 during actual processing or use, safety hazards occur. For ease of description, in the following embodiments, it is assumed that the battery cell 10 includes two tabs of different polarities (a first tab 200 and a second tab 400 respectively), the first tab 200 is insulated from the shell 12, and the second tab 400 is electrically connected to the shell 12, for example.

The insulation spacer 100 includes a first wall face 130 and a second wall face 140 opposite to each other along the thickness direction of the insulation spacer. A first hole 110 that penetrates the first wall face 130 and the second wall face 140 is created on the insulation spacer 100. A direction from the first wall face 130 to the second wall face 140 is a first direction X. The first hole 110 is configured to be passed through by the first tab 200 along the first direction X and enable the first tab to bend to closely fit the second wall face 140. The first wall face 130 of the insulation spacer 100 is oriented toward a current collecting assembly in the battery cell 10. The second wall face 140 of the insulation spacer 100 is oriented away from the current collecting assembly. The first hole 110 is a through-hole that penetrates the first wall face 130 and the second wall face 140, and the first hole 110 can be passed through by the first tab 200. When the first tab 200 passes through the first hole 110 and bends to closely fit the second wall face 140, the electrode post 11 (or another feedthrough connector) of the shell 12 abuts on a wall face of the first tab 200, the wall face being oriented away from the insulation spacer 100.

In the related art, the first tab does not pass through the insulation spacer, but the first tab passes around the lateral edge of the insulation spacer and bends to closely fit the second wall face. The lateral edge of the insulation spacer is opposite to the shell of the battery cell. Therefore, the bent part, located on the lateral edge of the insulation spacer, of the first tab is prone to contact the shell of the battery cell to form a short circuit, thereby causing danger. In this embodiment, the first tab 200 passes through the first hole 110 of the insulation spacer 100. The part, passing through the first hole 110, of the first tab 200 is surrounded by the insulation spacer 100, thereby effectively preventing the first tab 200 from contacting the shell 12, eliminating the risk of a short circuit of the battery cell 10, and improving the safety performance of the battery cell 10.

To reduce the processing difficulty, improve the processing efficiency, and facilitate the first tab 200 to pass through the first hole 110, referring to FIG. 1 to FIG. 3 and FIG. 12, the first tab 200 includes an intermediate portion 500 located in the first hole 110. The intermediate portion 500 is wrapped with a tab adhesive 300. The thickness direction of the intermediate portion 500 is a second direction Y. Along the second direction Y, a dimension L1 of the first hole 110, a thickness L2 of the first tab 200, and a thickness L3 of the tab adhesive 300 satisfy: 3≤L1/(L2+L3)≤5. As an example, the value of L1/(L2+L3) may be 3, 3.5, 4, 4.5, or 5. In other words, the dimension of the first hole 110 along the second direction Y is larger than an aggregate thickness of the first tab 200 and the tab adhesive 300, and the dimension of the first hole 110 along the second direction Y may be three to five times the aggregate thickness of the first tab 200 and the tab adhesive 300. The applicant hereof has demonstrated that, when L1/(L2+L3) is overly small, the process of the tab passing through the first hole 110 is troublesome. When L1/(L2+L3) is overly large, the first hole 110 is unable to constrain the tab, thereby causing the tab to wobble in the first hole 110 along the second direction Y. Therefore, the applicant hereof has demonstrated through experiments that, when the value of L1/(L2+L3) falls between three and five, not only the first tab 200 can pass through the first hole conveniently, but also the first hole can well constrain the intermediate portion 500 of the first tab 200.

It is hereby noted that the “intermediate portion 500” is not necessarily an exact middle part of the first tab 200, and the specific position of the intermediate portion 500 depends on the assembling requirements. In this embodiment, the “intermediate portion 500” means a part of the first tab 200, where the part is located between the two ends of the first tab and wrapped with the tab adhesive 300 and passes through the first hole 110. In addition, the L3 is the total thickness of the tab adhesive 300. In other words, when the first tab 200 is wrapped with the tab adhesive 300 on both sides along the thickness direction of the first tab, L3 is the sum of the thicknesses of the tab adhesives 300 on the two sides of the first tab 200. To further facilitate the tab to pass through the first hole 110, referring to FIG. 1 to FIG. 3 and FIG. 14, the direction perpendicular to the first direction X and perpendicular to the second direction Y is a third direction Z. Along the third direction Z, a dimension L4 of the first hole 110 and a width L5 of the tab adhesive 300 satisfy: 1.2≤L4/L5≤1.5. As an example, the value of L4/L5 may be 1.2, 1.3, 1.4, or 1.5. The applicant hereof considers that, when the dimension of the first hole 110 along the third direction Z is overly small, the tab adhesive 300 is caused to abut onto the first wall face 130 in a process of the first tab 200 passing through the first hole 110, thereby hindering the first tab 200 from passing through the first hole 110. When the dimension of the first hole 110 along the third direction Z is overly large, the effect of the first hole 110 in constraining the first tab 200 is not significant, so that the first tab 200 is prone to wobble in the first hole 110 along the third direction Z. The applicant hereof has demonstrated that, when 1.2≤L4/L5≤1.5, the first hole 110 not only facilitates passage of the first tab 200, but also well constrains the first tab 200.

Further, in an embodiment, referring to FIG. 1 to FIG. 3, along the second direction Y, the insulation spacer 100 includes a first lateral edge 150 and a second lateral edge 160 arranged opposite to each other. A shortest distance H1 from the first hole 110 to the first lateral edge 150 and a distance H2 from the first lateral edge 150 to the second lateral edge 160 satisfy: 0.25≤H1/H2≤0.5. As an example, the value of H1/H2 may be 0.25, 0.3, 0.35, 0.4, 0.45, or 0.5. The applicant hereof has heeded that, when the first hole 110 is farther away from the lateral edge of the insulation spacer 100, the arrangement space of the first tab 200 that has passed through the insulation spacer 100 is smaller; when the first hole 110 is closer to the lateral edge of the insulation spacer 100, the risk of the first tab 200 contacting the shell 12 of the battery cell 10 is higher. The applicant hereof demonstrates that, when 0.25≤H1/H2≤0.5, the arrangement space can meet requirements after the first tab 200 passes through the insulation spacer 100. At the same time, the distance between the first tab 200 and the lateral edge of the insulation spacer 100 meets the requirements. The risk of contact between the first tab 200 and the shell 12 is low.

Referring to FIG. 4 to FIG. 8, the first wall face 130 and/or the second wall face 140 may be connected to the supporting portion 170. To be specific, in an embodiment, the supporting portion 170 is disposed on the first wall face 130, but the supporting portion 170 is not disposed on the second wall face 140. In another embodiment, the supporting portion 170 is not disposed on the first wall face 130, but the supporting portion 170 is disposed on the second wall face 140. In still another embodiment, the supporting portion 170 is disposed on both the first wall face 130 and the second wall face 140. For ease of description, the following embodiment is exemplified by a technical solution in which the supporting portion 170 is disposed on both the first wall face 130 and the second wall face 140.

The supporting portion 170 is disposed between the first hole 110 and the first lateral edge 150. The supporting portion 170 includes a third wall face 171 oriented away from the first lateral edge 150. The first hole 110 includes a first hole wall 111 close to the first lateral edge 150. The first hole wall 111 and the third wall face 171 are consecutive and combine to form a continuous wall face 190. In other words, in this embodiment, the supporting portion 170 enables the first hole wall 111 of the first hole 110 to flare out along the first direction X (the flared wall face is called a continuous wall face 190), where the first hole wall is close to the first lateral edge 150 of the insulation spacer 100. In this way, the continuous wall face 190 more effectively supports the intermediate portion 500 of the first tab 200, thereby effectively avoiding the risk that the intermediate portion 500 detaches from the first hole wall 111, moves toward the first lateral edge 150 of the insulation spacer 100, and comes into contact with the shell 12 of the battery cell 10.

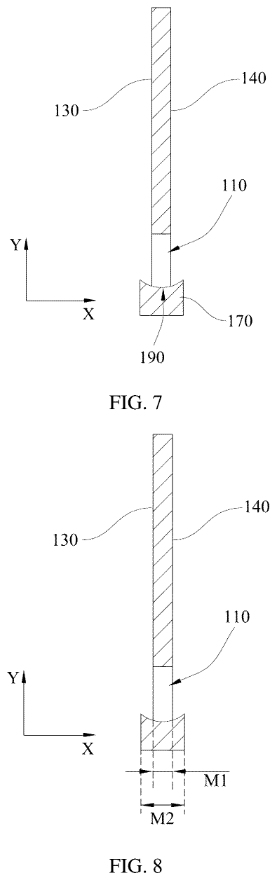

Further, in an embodiment, the continuous wall face 190 is a flat face. Alternatively, the continuous wall face 190 is an arc face shown in FIG. 7. The continuous wall face 190 is recessed toward the first lateral edge 150 from the interior of the insulation spacer along the thickness direction of the insulation spacer 100. When the continuous wall face 190 is an arc face shown in FIG. 7, the continuous wall face 190 more effectively supports the intermediate portion 500 of the first tab 200, and can more effectively prevent the intermediate portion 500 from detaching from the continuous wall face 190.

In an embodiment, along the first direction X, a width M1 of the continuous wall face 190 and a width M2 of the first hole wall 111 satisfy: 1.5≤M1/M2≤2. As an example, the value of M1/M2 may be 1.5, 1.6, 1.7, 1.8, 1.9, or 2. The applicant hereof finds that, when 1.5≤M1/M2≤2, the overall thickness of the insulation spacer 100 is not overly large, thereby preventing the insulation spacer 100 from occupying too much space in the battery cell 10. In addition, the dimension of the continuous wall face 190 along the first direction X is not overly small, thereby ensuring that the continuous wall face 190 can effectively support the intermediate portion 500 of the first tab 200.

To improve the effect of supporting the intermediate portion 500 of the first tab 200, in an embodiment, the direction perpendicular to the first direction X and perpendicular to the second direction Y is a third direction Z. Along the third direction Z, the length of the third wall face 171 is identical to the length of the first hole wall 111.

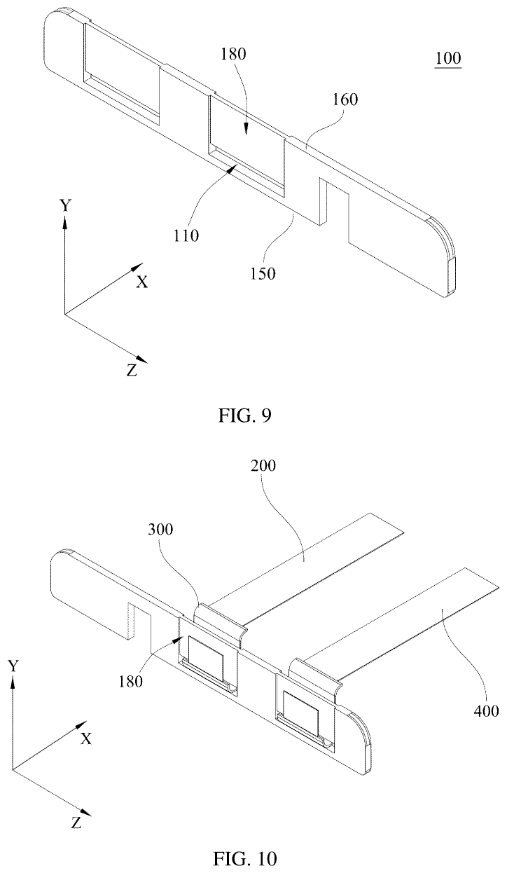

Referring to FIG. 9 to FIG. 15, in an embodiment, the first hole 110 further includes a second hole wall 112 close to the second lateral edge 160. A first groove 180 is created at a part of the second wall face 140, and the part is located between the first hole 110 and the second lateral edge 160. The first groove 180 extends to the second lateral edge 160 and the second hole wall 112 separately. The first groove 180 is configured to accommodate at least a part of the first tab 200 along the first direction X. In the above technical solution, the part, passing through the first hole 110, of the first tab 200 can be accommodated in the first groove 180 and constrained by the first groove 180, thereby preventing the part, passing through the first groove 180, of the first tab 200 from moving along the second direction Y. In addition, in an embodiment, the first groove 180 can also reduce the thickness of the insulation spacer 100, thereby reducing the space occupied by the insulation spacer 100 in the battery cell 10 and increasing the energy density of the battery cell 10.

Further, in an embodiment, along the third direction Z, the dimension of the first groove 180 is equal to the dimension of the first hole 110. This structure makes the first groove 180 more easily processable, and also makes the first groove match the dimension of the first tab 200 along the second direction Y. In this way, on the one hand, the first tab 200 is prevented from being stuck by the overly small dimension of the first groove 180 along the second direction Y. On the other hand, the effect of the first groove 180 in constraining the first tab 200 is prevented from being weakened by the overly large dimension of the first groove 180 along the second direction Y.

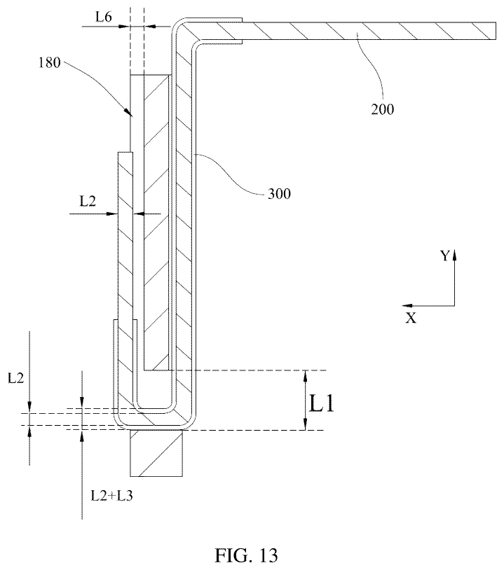

Referring to FIG. 13, along the first direction X, the depth L6 of the first groove 180 and the thickness L2 of the first tab 200 satisfy: 0.8≤L6/L2≤1. As an example, the value of L6/L2 may be 0.8, 0.9, or 1. When 0.8≤L6/L2≤1, the first groove 180 is prevented from being overly deep and in turn resulting in an excessive thickness of the insulation spacer 100, and the first groove 180 is also prevented from being overly shallow and in turn ineffective in constraining the first tab 200.

Further, in an embodiment, the first hole 110 further includes a second hole wall 112 close to the second lateral edge 160. A second groove 181 is created at a part of the first wall face 130, and the part is located between the first hole 110 and the second lateral edge 160. The second groove 181 extends to the second lateral edge 160 and the second hole wall 112 separately. The second groove 181 is configured to accommodate at least a part of the first tab 200 along the first direction X. In other words, a second groove 181 may be created at a position opposite to the first groove 180 and located on the first wall face 130 of the insulation spacer 100. The second groove 181 is configured to constrain the first tab 200 located on one side of the first wall face 130 of the insulation spacer 100, so that the first tab 200 is positioned more properly.

Similarly, in an embodiment, along the third direction Z, the dimension of the second groove 181 may be equal to the dimension of the first hole 110. The second groove 181 is more easily processable, and the second groove 181 can match the dimension of the first tab 200 along the second direction Y.

Further, in an embodiment, a tab adhesive 300 is disposed at a part of the first tab 200, and the part is located in the second groove 181. Along the first direction X, a depth L7 of the second groove 181, a thickness L2 of the first tab 200, and a thickness L3 of the tab adhesive 300 satisfy: 0.8≤L7/(L2+L3)≤1. As an example, the value of L7/(L2+L3) may be 0.8, 0.9, or 1. When 0.8≤L7/(L2+L3)≤1, the second groove 181 is prevented from being overly deep and in turn resulting in an excessive thickness of the insulation spacer 100, and the second groove 181 is also prevented from being overly shallow and in turn ineffective in constraining the first tab 200.

When both the first tab 200 and the second tab 400 of the battery cell 10 are insulated from the shell 12, it is also necessary to prevent the second tab 400 from contacting the shell 12. Therefore, in an embodiment, referring to FIG. 16, a second hole 120 penetrating the first wall face 130 and the second wall face 140 is further created on the insulation spacer 100. The second hole 120 is configured to be passed through by the second tab 400 along the first direction X and enable the second tab to bend to closely fit the second wall face 140. In this embodiment, the specific structure and parameters of the second hole 120 can be learned by referring to the description of the first hole 110 in the above embodiment, details of which are omitted here.

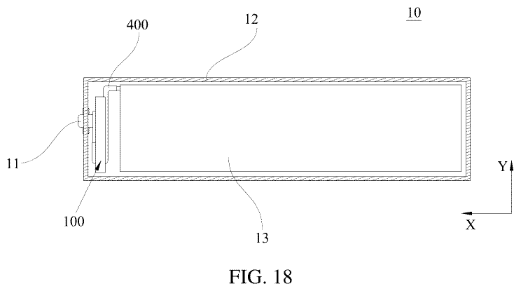

Referring to FIG. 17 to FIG. 18, in an embodiment, when the second tab 400 is electrically connected to the shell 12 of the battery cell 10, it is not necessary to consider whether the second tab 400 is in contact with the shell 12. In this case, a notch 190 is created at the first lateral edge 150. The notch 190 is configured to accommodate the second tab 400. The notch 190 includes a fourth wall face 191 away from the first lateral edge 150. The first hole 110 includes a second hole wall 112 away from the first lateral edge 150. The fourth wall face 191 is parallel to or coplanar with the second hole wall 112. The structure in which the fourth wall face 191 is parallel to or coplanar with the second hole wall 112 enables the first tab 200 and the second tab 400 to be located at the same height. The sizes may be matched between the two tabs, thereby making it convenient to process and assemble the first tab 200 and the second tab 400. Further, the structure of the notch 190 also facilitates the assembling of the second tab 400.

A second aspect of this application further provides a battery cell 10. The battery cell 10 includes the insulation spacer 100 disclosed in any one of the above embodiments.

A third aspect of this application further provides a battery. The battery includes one or more battery cells 10 disclosed in the above embodiment.

A fourth aspect of this application further provides an electrical device. The electrical device includes the battery disclosed in the above embodiment.

It is hereby noted that although preferred embodiments of this application have been given in the specification and drawings of this application, this application may be implemented in many different forms, without being limited to the embodiments described herein. The embodiments are not intended to limit the content of this application, but merely to facilitate thorough and comprehensive understanding of the content disclosed herein. In addition, all kinds of embodiments that are not enumerated above but are derived by further combination of the foregoing technical features still fall within the scope covered by this application. Further, all improvements and variations, which may be made by a person of ordinary skill in the art based on the foregoing description, still fall within the protection scope of the claims appended hereto.

What is claimed is:

1. A battery cell, wherein the battery cell comprises an insulation spacer, a shell, a first tab, and a second tab of an opposite polarity to the first tab; the first tab is insulated from the shell;
wherein, the insulation spacer comprises a first wall face and a second wall face opposite to each other along a thickness direction of the insulation spacer, a first hole is provided on the insulation spacer, the first hole penetrates the first wall face and the second wall face, a direction from the first wall face to the second wall face is a first direction; and
the first tab passes through the first hole along the first direction and the first tab is bended to fit with the second wall face.

2. The battery cell according to claim 1, wherein
the first tab comprises an intermediate portion located in the first hole, the intermediate portion is wrapped with a tab adhesive, a thickness direction of the intermediate portion is a second direction; along the second direction, a dimension L1 of the first hole, a thickness L2 of the first tab, and a thickness L3 of the tab adhesive satisfy: 3≤L1/(L2+L3)≤5.

3. The battery cell according to claim 1, wherein
the first tab comprises an intermediate portion located in the first hole, the intermediate portion is wrapped with a tab adhesive, a thickness direction of the intermediate portion is a second direction, a direction perpendicular to the first direction and perpendicular to the second direction is a third direction; and, along the third direction, a dimension L4 of the first hole and a width L5 of the tab adhesive satisfy: 1.2≤L4/L5≤1.5.

4. The battery cell according to claim 1, wherein
the first tab comprises an intermediate portion located in the first hole, the intermediate portion is wrapped with a tab adhesive, a thickness direction of the intermediate portion is a second direction; and, along the second direction, the insulation spacer comprises a first lateral edge and a second lateral edge arranged opposite to each other, and a shortest distance H1 from the first hole to the first lateral edge and a distance H2 from the first lateral edge to the second lateral edge satisfy: 0.25≤H1/H2≤0.5.

5. The battery cell according to claim 4, wherein
the first wall face and/or the second wall face is connected to a supporting portion, the supporting portion is disposed between the first hole and the first lateral edge, and the supporting portion comprises a third wall face oriented away from the first lateral edge; and
a first hole wall surrounds the first hole from a first side towards the first lateral edge, and the first hole wall and the third wall face are consecutive and combine to form a continuous wall face.

6. The battery cell according to claim 5, wherein
the continuous wall face is a flat face;
or,
the continuous wall face is an arc face, and the continuous wall face is recessed toward the first lateral edge from an interior of the insulation spacer along a thickness direction of the insulation spacer.

7. The battery cell according to claim 5, wherein
along the first direction, a width M1 of the continuous wall face and a width M2 of the first hole wall satisfy: 1.5≤M1/M2≤2.

8. The battery cell according to claim 5, wherein
a direction perpendicular to the first direction and perpendicular to the second direction is a third direction; and, along the third direction, a length of the third wall face is identical to a length of the first hole wall.

9. The battery cell according to claim 5, wherein
a second hole wall surrounds the first hole from a second side towards the second lateral edge, a first groove is provided at a part of the second wall face, the part of the second wall face is located between the first hole and the second lateral edge, the first groove extends to the second lateral edge and the second hole wall separately, and the first groove is configured to accommodate at least a part of the first tab along the first direction.

10. The battery cell according to claim 9, wherein
a direction perpendicular to the first direction and perpendicular to the second direction is a third direction; and, along the third direction, a dimension of the first groove is equal to a dimension of the first hole.

11. The battery cell according to claim 10, wherein
along the first direction, a depth L6 of the first groove and a thickness L2 of the first tab satisfy: 0.8≤L6/L2≤1.

12. The battery cell according to claim 9, wherein
a second groove is provided at a part of the first wall face, the part of the first wall face is located between the first hole and the second lateral edge, the second groove extends to the second lateral edge and the second hole wall separately, and the second groove is configured to accommodate at least a part of the first tab along the first direction.

13. The battery cell according to claim 12, wherein
a direction perpendicular to the first direction and perpendicular to the second direction is a third direction; and, along the third direction, a dimension of the second groove is equal to a dimension of the first hole.

14. The battery cell according to claim 13, wherein
a tab adhesive is disposed at a part of the first tab, the part of the first tab is located in the second groove; and, along the first direction, a depth L7 of the second groove, a thickness L2 of the first tab, and a thickness L3 of the tab adhesive satisfy: 0.8≤L7/(L2+L3)≤1.

15. The battery cell according to claim 1, further comprises a second hole penetrating the first wall face and the second wall face, the second tab passes through the second hole along the first direction, and the second tab bends to fit the second wall face.

16. The battery cell according to claim 4, wherein
a notch is provided at the first lateral edge, the notch is configured to accommodate the second tab, the notch comprises a fourth wall face away from the first lateral edge, a second hole wall surrounds the first hole from a side away from the first lateral edge, and the fourth wall face is parallel to or coplanar with the second hole wall.

17. A battery, wherein the battery comprises one or more battery cells, wherein each battery cell is the battery cell according to claim 1.

18. The battery according to claim 17, wherein
the first tab comprises an intermediate portion located in the first hole, the intermediate portion is wrapped with a tab adhesive, a thickness direction of the intermediate portion is a second direction, and, along the second direction, a dimension L1 of the first hole, a thickness L2 of the first tab, and a thickness L3 of the tab adhesive satisfy: 3≤L1/(L2+L3)≤5.

19. The battery according to claim 18, wherein
the first tab comprises an intermediate portion located in the first hole, the intermediate portion is wrapped with a tab adhesive, a thickness direction of the intermediate portion is a second direction, a direction perpendicular to the first direction and perpendicular to the second direction is a third direction, and, along the third direction, a dimension LA of the first hole and a width L5 of the tab adhesive satisfy: 1.2≤L4/L5≤1.5.

20. An electrical device, wherein the electrical device comprises the battery according to claim 17.
